(19) United States
(12) Patent Application Publication
(10) Pub. No.: US 2007/0203619 A1
(43) Pub. Date: Aug. 30, 2007

(54) Method and apparatus for calculating engine power and best power

(76) Inventors: Michael J. Ingram, Melbourne, FL (US); Rick Willard, Camarillo, CA (US); Mark George Lyon, Newtonville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/636,415

(22) Filed: Dec. 8, 2006

Related U.S. Application Data
(63) Continuation-in-part of application No. 10/868,246, filed on Jun. 14, 2004.
(60) Provisional application No. 60/478,686, filed on Jun. 13, 2003.

(51) Int. Cl. G01C 23/00

(52) U.S. Cl. 701/3

(57) ABSTRACT

A method, computer program, or apparatus for determining with various degrees of precision the power delivered by an engine and also the best possible power of the engine for the given operating conditions. Typically, this invention is for an aircraft engine. The disclosed invention uses a variety of parameters, such as the rotation rate, manifold pressure, outside air temperature, and fuel flow to calculate or approximate the power delivered by the engine and the best power available from the engine. The engine's altitude does not have to be involved in the calculations. Display of the calculated engine power is provided relative to best power and/or maximum engine power.

### RELATED APPLICATIONS

This application is a Continuation-In-Part of U.S. patent application Ser. No. 10/868,246, filed Jun. 14, 2004, which claims the benefit of U.S. Provisional Application No. 60/478,686, filed Jun. 13, 2003, the entire teachings of which are incorporated herein by reference.

### BACKGROUND OF THE INVENTION

This invention relates to the broad category of engines which operate by converting the energy of combustion of a mixture comprising fuel and air into a periodic mechanical motion. A variety of such engines is known in the pertinent art. Such engines are widely used on various aircrafts.

In engineering or physical terms, the foregoing mechanical motion is “work” and the rate at which the “work” is done is “power”. The power delivered by an engine is an important value that must be monitored in many situations where an engine is used. Usually the power cannot be measured directly and must be calculated using a variety of values gathered through various measuring means and then mathematically combined to present the user, such as a pilot, with the amount of power delivered by the engine at a given moment.

### SUMMARY OF THE INVENTION

The present invention provides a method, apparatus or a computer program product for determining the power of an engine by (1) obtaining an HP₀, where HP₀ is a mathematical combination of the engine's rotation rate and of the engine's manifold pressure, (2) obtaining an HP₁, where HP₁ is a mathematical combination of the engine's outside air temperature and of the HP₀, or (3) obtaining an HP₂, where HP₂ is a mathematical combination of the engine's fuel flow rate and of the HP₁, and for determining the best power HP_{BP} of the engine and displaying to the engine operator HP₂ relative to HP_{BP} and/or relative to the maximum power HP_{MAX} of the engine.

Such method, apparatus or a computer program may be used with an aircraft engine and does not have to involve the engine's measured altitude.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a graph showing the dependence of a Teledyne Continental IO-360-ES engine's actual full throttle power output on manifold pressure at different rates of the engine's rotation at sea level under International Standard Atmosphere (ISA) conditions.

FIG. 2 is a graph showing a typical dependence of the calculated power output of a Teledyne Continental IO-360-ES engine on the fuel flow into the engine.

FIG. 3 is a graph showing a typical dependence of discrepancies between the actual and calculated power produced by a Teledyne Continental IO-360-ES engine on the engine's altitude at ISA conditions.

FIG. 4 is a graph showing a typical dependence of discrepancies between the actual and calculated power produced by a Teledyne Continental IO-360-ES engine on the engine's altitude at ISA-30° C. conditions.

FIG. 5 is a graph showing a typical dependence of discrepancies between the actual and calculated power produced by a Teledyne Continental IO-360-ES engine on the engine's altitude at ISA+30° C. conditions.

FIG. 6 is a graph showing the dependence of a Teledyne Continental IO-550-N engine's actual full throttle power output on manifold pressure at different rates of the engine's rotation at sea level under ISA conditions.

FIG. 7 is a graph showing a typical dependence of the calculated power output of a Teledyne Continental IO-550-N engine on the fuel flow into the engine.

FIG. 8 is a graph showing a typical dependence of discrepancies between the actual and calculated power produced by a Teledyne Continental IO-550-N engine on the engine's altitude at ISA conditions.

FIG. 9 is a graph showing a typical dependence of discrepancies between the actual and calculated power produced by a Teledyne Continental IO-550-N engine on the engine's altitude at ISA-30° C. conditions.

FIG. 10 is a graph showing a typical dependence of discrepancies between the actual and calculated power produced by a Teledyne Continental IO-550-N engine on the engine's altitude at ISA+30° C. conditions.

FIG. 11 a flow chart of one embodiment of the present invention.

FIGS. 12A-12H illustrates eight possible embodiments of the display of engine power of the present invention.

FIGS. 13A-13C illustrates two further embodiments of the display of engine power of the present invention wherein both calculated power and best power are shown relative to the maximum power of the engine.

### DETAILED DESCRIPTION OF THE INVENTION

A description of preferred embodiments of the invention follows.

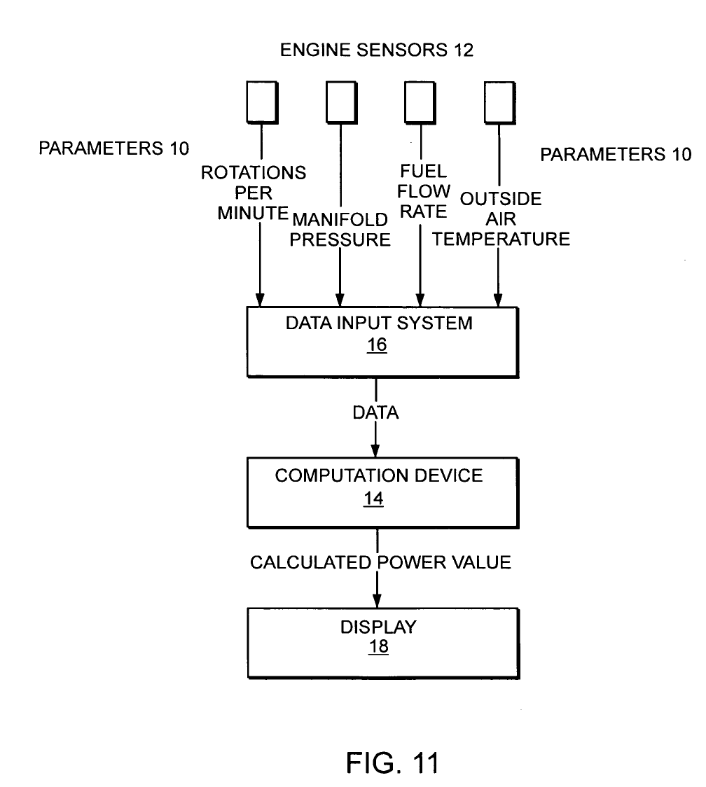

With reference to FIG. 11, the embodiments of this invention use a variety of parameters 10 in determining the power output of an engine (hereinafter expressed in horsepower units). The parameters 10 may include RPM (number of engine rotations per minute), manifold pressure (pressure on the engine's air intake, hereinafter expressed in inches of mercury, inches Hg), outside air temperature (hereinafter expressed in degrees Celsius, ° C.), and fuel flow into the engine (hereinafter expressed in gallons per hour, GPH).

Respective sensors 12, as typically used in aircraft, generate the values of these parameters 10. The values of these parameters are received at an input system 16 and fed into a computation device 14. The computation device 14 may be a microchip or a computer running a software program mathematically combining the values of the parameters 10. The number produced by the computation device 14 representing an approximate value of the engine's power output is sent from the computation device 14 to a display system 18 to be presented to the engine's user. The engine's power output value may be presented, for example, as a number on a numeric display, as a position of an arrow on a meter, scale or the like, etc. In some embodiments, the user is presented not with an absolute value but with the percentage or ratio of the current power output and some fixed value, such as the maximum power HP_{MAX} output of the engine. In yet other embodiments, the invention display 18 indicates current power output relative to (e.g., as a percentage of) best power HP_{BP} and/or relative to HP_{MAX}.

In some embodiments, the computation device 14 mathematically combines the detected engine's rotation rate and manifold pressure to obtain an HP₀ value (one approximation of the power delivered by the engine). Subsequently, the computation device 14 mathematically combines the detected outside air temperature of the engine and HP₀ to obtain an HP₁ value (another approximation of the power delivered by the engine). The computation device 14 then may mathematically combine the detected engine's fuel rate and HP₁ value to obtain an HP₂ value (a third approximation of the power delivered by the engine).

Again, the engine's calculated power output based on HP₂ may be presented, for example, as a number on a numeric display, as a position of an arrow on a meter, scale or the like, etc. In some embodiments, the user is presented not with an absolute value but with the percentage or ratio of the current calculated power HP₂ and some other value of engine power. The maximum power HP_{MAX} output of the engine is one such value against which the current power output may be compared. An alternative value is the best power HP_{BP} the engine is capable of producing at the current engine speed, manifold pressure, and outside air temperature.

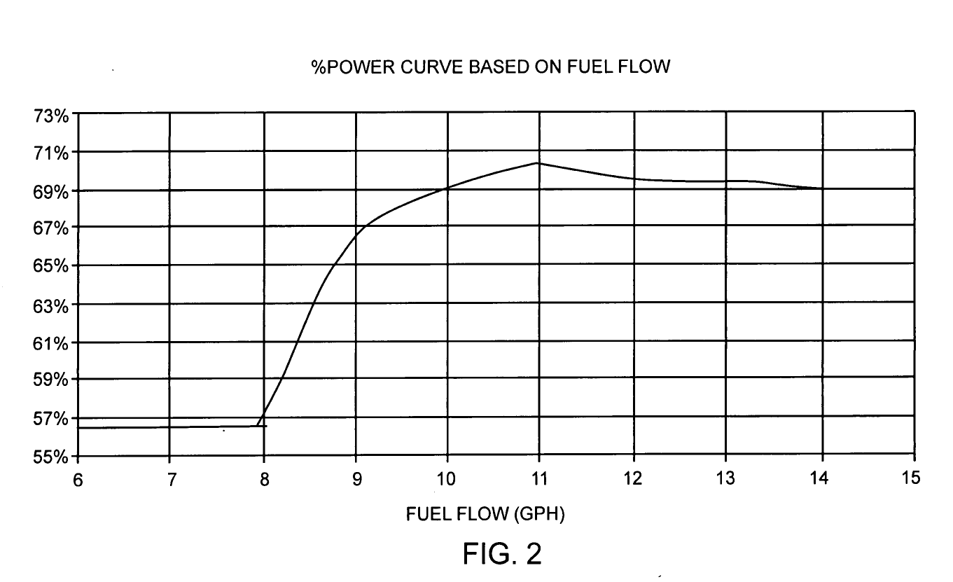

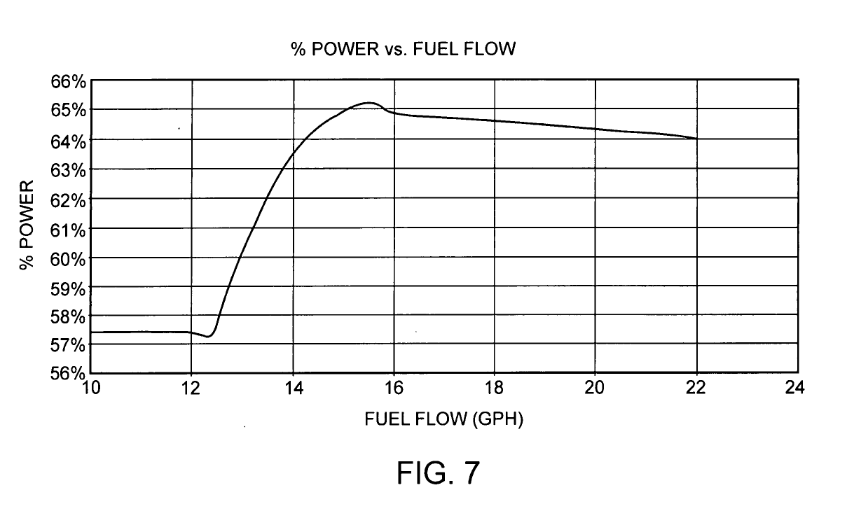

The best power that an engine is capable of acheiving at a given engine speed, manifold pressure and outside air temperature is dependent upon the rate of fuel flow to the engine. As illustrated by FIGS. 2 and 7, an engine operating at a given speed and manifold pressure, and operating with a given outside air temperature, will acheive a peak power output (or “best power”) HP_{BP} at a specific rate of fuel flow F_{BP}. The fuel flow at which best power is achieved F_{BP} may be determined by the computation device 14 by performing a mathematic operation on the HP₁ value. U.S. Pat. No. 7,039,518 (incorporated herein by reference) discloses various such systems for obtaining a best power fuel flow. Once F_{BP} has been calculated, the best power HP_{BP} of the engine may be computed. The engine's actual power output HP₂ may then be compared to the best power HP_{BP} by the computation device 14 and the actual power HP₂ may be presented as a percentage or ratio of the computed current best power HP_{BP}. Each of HP₀, HP₁, HP₂, HP_{BP}, and F_{BP} are further explained in the examples below.

Accordingly, some embodiments of this invention determine the engine's power output by making progressively better approximations of the value sought by incorporating additional parameters into the calculations.

The term “ISA conditions” is used in the pertinent art and throughout this specification in the sense of the ambient sea level temperature being 15° C. A usual assumption made for ISA conditions is a temperature decrease of 1.98° C. per 1000 feet of altitude increase.

One embodiment of this invention is used to measure the power output of a Teledyne Continental IO-360-ES engine installed on Cirrus Design Corporation's SR-20 aircraft. The maximum power HP_{MAX} output of this engine is 200 horsepower.

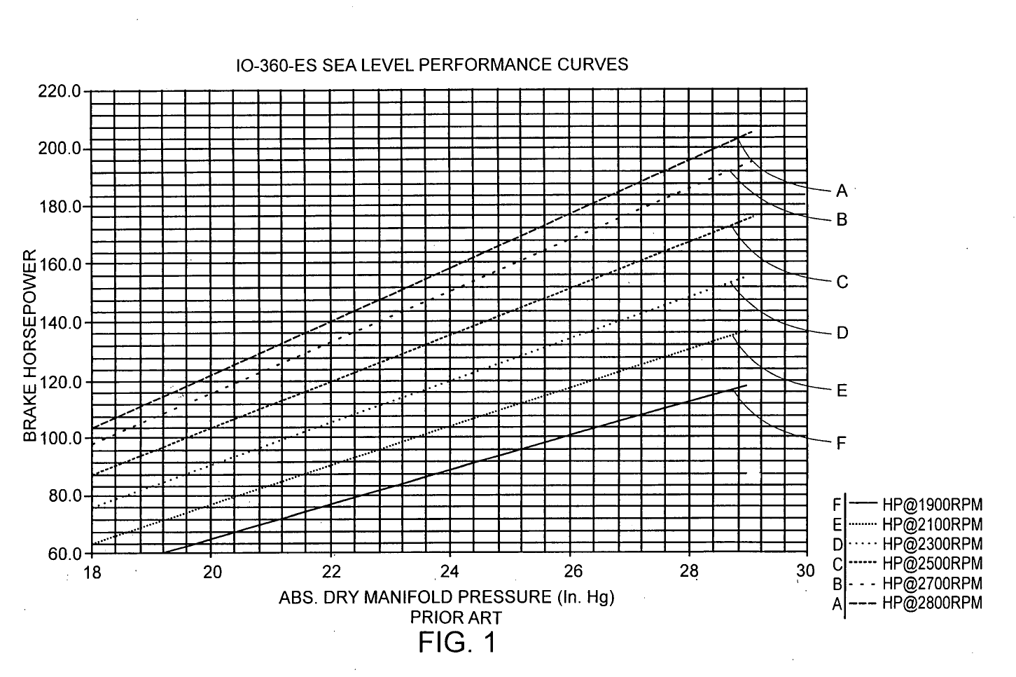

FIG. 1 shows the dependence of the engine's actual full throttle power output (expressed on the vertical axis in horsepower) on manifold pressure (expressed on the horizontal axis in inches Hg) for different rates of the engine's rotation (expressed in RPM) at the sea level under the ISA conditions.

For this engine, the power output may be approximately calculated as HP₀ using manifold pressure, P, and engine rotations per minute, R, as
HP₀=−22.−0.009×R−1.15×P+0.00366×P×R.

A better approximation of the power output, HP_{I}, may be calculated by taking into account the outside air temperature, T, as
HP₁=HP₀×((15.−T)×0.0062+1.).

Note that HP₁=HP₀ when T=15° C.

The precision of the power output calculation may be further improved under the following combination of conditions:

(1) HP₁ is between 30% and 80% of the maximum power output of the engine;

(2) the fuel flow into the engine, F, is less than 12.5 gallons per minute; and

(3) F<0.063×HP₁+5.

If the above conditions are true, the improved approximation for the engine's power output, HP₂, at a given fuel flow, F, may be calculated as

if F<(F_{BP}−3.), i.e. lean mix,
HP₂=HP₁−1.96×(−3.)²+1.06×(−3.);

if (F_{BP}−3.)≦F≦F_{BP},
HP₂=HP₁+(−1.96×(F−(0.064×HP₁+2.51))²+1.06×(F−(0.064×HP₁+2.51)); and

if F_{BP}<F, i.e. rich mix,
HP₂=HP₁+(−0.421×(F−(0.064×HP₁+2.51))−0.628);

where F_{BP} is the fuel flow at which the engine operates at its best power for the given manifold pressure, rotation rate, and outside air temperature. F_{BP} is the fuel flow based on the engine specifications curve estimated by the equation
F_{BP}=(0.064×HP₁)+2.51

F_{BP} is a curve for the full rich value at specific HP₂. Typically, F_{BP} is in the range from 8.5 to 16. gallons per hour.

FIG. 2 shows a typical dependence of the power output of the engine (expressed on the vertical axis as percentage of the engine's maximum power HP_{MAX}) calculated as HP₂ on the fuel flow into the engine (expressed on the horizontal axis in gallons per hour) at a fixed value of HP₁.

Note that best power HP_{BP} is determined in the above equations by setting F equal to F_{BP}, and then, HP_{BP} is equal to HP₁.

Note further that the methods for calculating the engine's power used in embodiments of the present invention do not depend on the engine's altitude, which is an important advantage of the invention. In other words, the computation device 14 (FIG. 11) does not employ the measured or sensed aircraft altitude in its operations when producing values HP₀, HP₁, HP₂, and HP_{BP} for subsequent display on display 18 (FIG. 11).

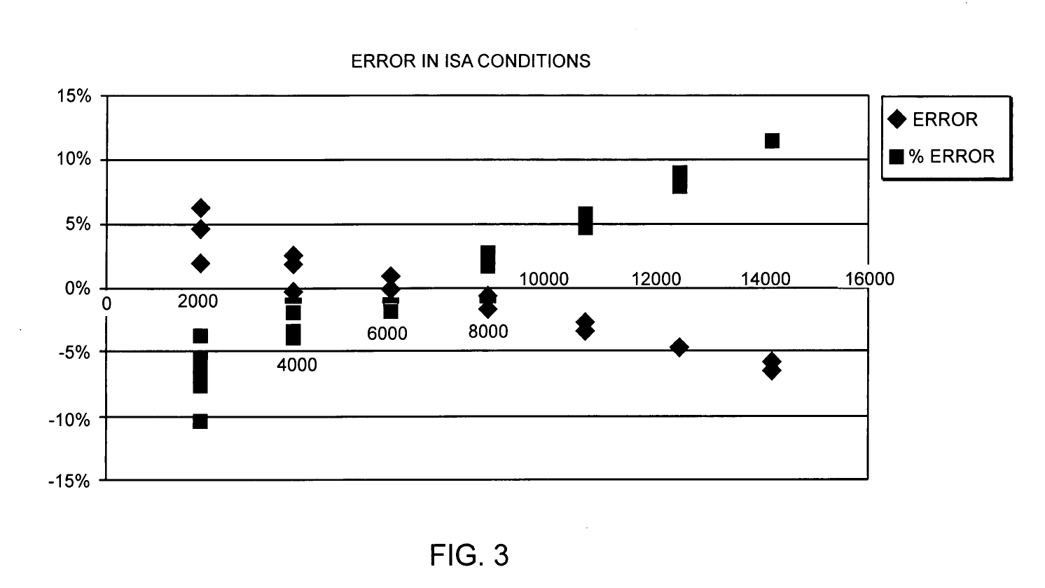

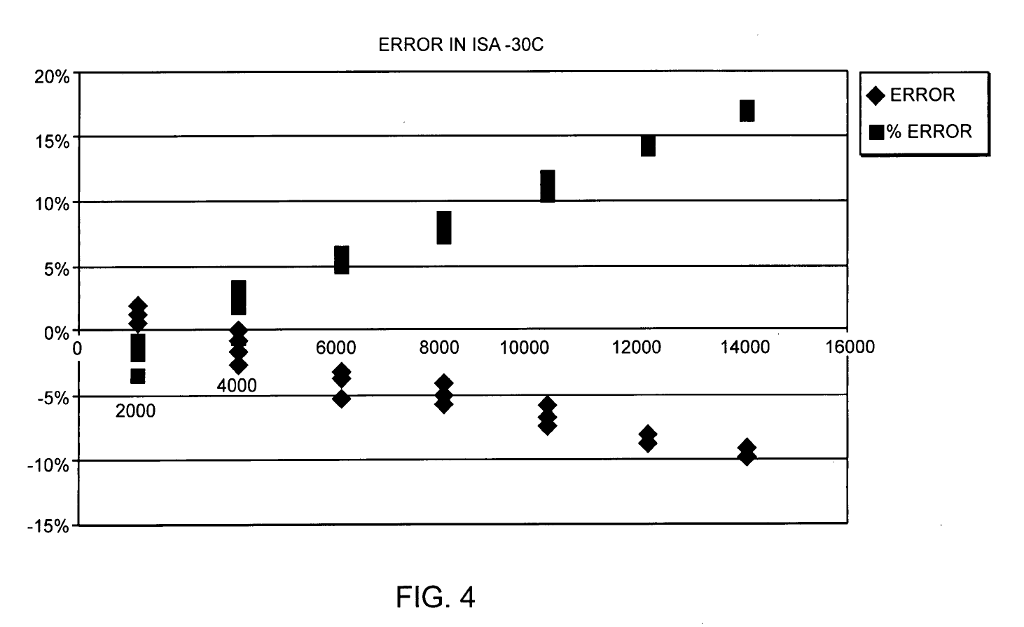

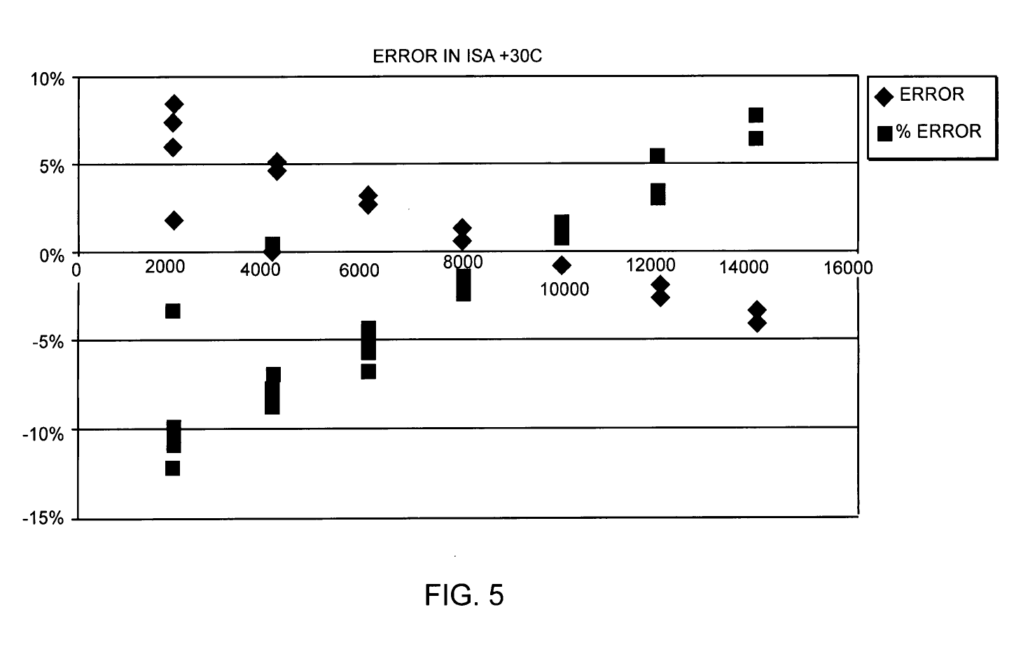

FIGS. 3, 4, and 5 show a typical dependence of discrepancies between the actual power produced by the engine and HP₁ and HP₂ (where available) on the engine's altitude (expressed on the horizontal axis in feet) at ISA conditions (FIG. 3), at ISA −30° C. (i.e., ambient sea level temperature being −15° C., FIG. 4), and at ISA +30° C. (i.e., ambient sea level temperature being 45° C., FIG. 5). In FIGS. 3, 4, and 5, the discrepancies produced by the above method for this engine are shown by diamonds as difference between the calculated and actual engine power (expressed as percentage of the engine's maximum power) and by squares as the percentage difference between the calculated and actual engine's power.

As can be seen from FIGS. 3, 4, and 5, at the ISA conditions, the invention method for this engine works the best (has lower error) between approximately 6,000 and 8,000 feet of altitude.

Another embodiment of this invention is used to measure the power output of a Teledyne Continental IO-550-N engine installed on Cirrus Design Corporation's SR-22 aircraft. The maximum power HP_{MAX} output of this engine is 310 horsepower.

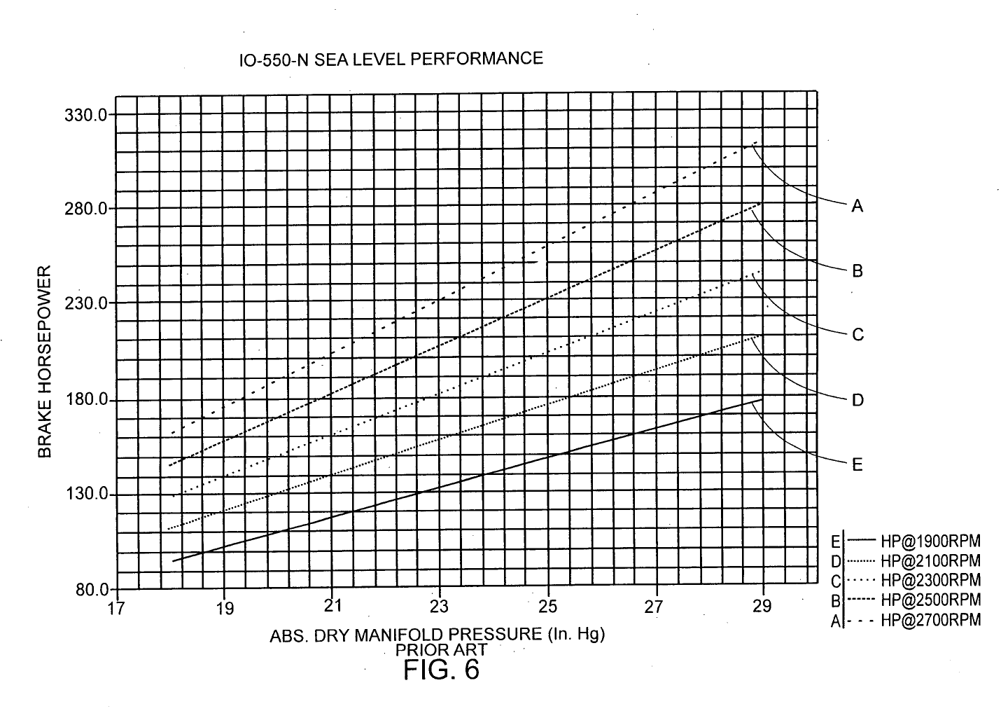

FIG. 6 shows the dependence of the engine's actual full throttle power output (expressed on the vertical axis in horsepower) on manifold pressure (expressed on the horizontal axis in inches Hg) for different rates of the engine's rotation (expressed in RPM) at sea level under the ISO conditions.

For this engine, the power output may be approximately calculated as HP₀ using manifold pressure, P, and engine rotations per minute, R, as
HP₀=86.−0.0543×R−7.×P+0.0077×P×R.

A better approximation of the power output, HP₁, may be calculated by taking into account the outside air temperature, T, as
HP₁=HP₀×((16.−T)×0.02+1.).

Note that HP₁=HP₀ when T=16° C.

The precision of the power output calculation may be further improved under the following combination of conditions:

(1) HP₁ is between 30% and 80% of the maximum power output of the engine;

(2) the fuel flow into the engine, F, is less than 18.0 gallons per minute; and

(3) F<0.063×HP₁+5.

If the above conditions are true, the improved approximation for the engine's power output, HP₂, at a given fuel flow, F, may be calculated as

if F<(F_{BP}−3.), i.e. lean mix,
HP₂=HP₁−(0.00151×(−3.)³+2.99×(−3.)²−(−3.)−0.1935);

if (F_{BP}−3.)≦F≦F_{BP},
HP₂=HP₁+(0.00151×(F−(0.048×HP₁+4.15))³)+(−2.99×(F−(0.048×HP₁+4.15))²)−(F−(0.048×HP₁+4.15))−0.1935; and

if F_{BP}<F, i.e. rich mix,
HP₂=HP₁+(−0.421×(F−(0.048×HP₁+4.15))−0.628);

where F_{BP} is the fuel flow at which the engine operates at its best power for the given manifold pressure, rotation rate, and outside air temperature. F_{BP} is the fuel flow based on the engine specifications curve estimated by the equation
F_{BP}=0.048×HP₁+4.15

F_{BP} is a curve for the full rich value at specific HP₂. Typically, F_{BP} is in the range from 8. to 15. gallons per hour

FIG. 7 shows a typical dependence of the power output of the engine (expressed on the vertical axis as percentage of the engine's maximum power HP_{MAX}) calculated as HP_{BP} on the fuel flow into the engine (expressed on the horizontal axis in gallons per hour) at a fixed value of HP₁.

Note that best power HP_{BP} is determined in the above equations by setting F equal to F_{BP}. Notice that for this particular embodiment of the invention, HP_{BP} is equal to HP₁.

Note further that the methods for calculating the engine's power used in this embodiment do not depend on the engine's altitude, which is an important advantage of this embodiment of the invention. In other words, the computation device 14 (FIG. 11) does not employ the measured or sensed aircraft altitude in its operations when producing values HP₀, HP₁, HP₂, and HP_{BP} for subsequent display on display 18 (FIG. 11).

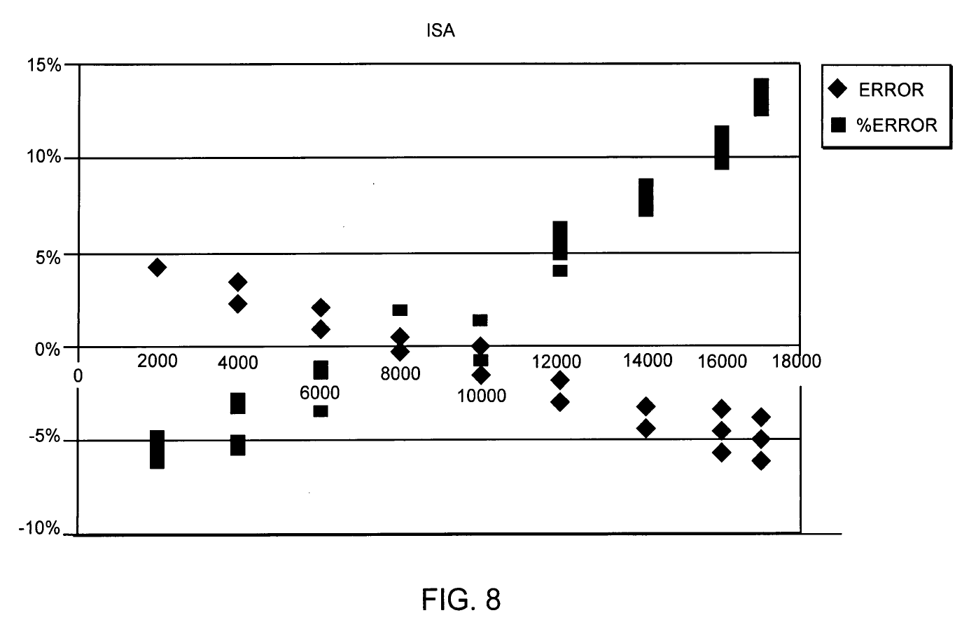

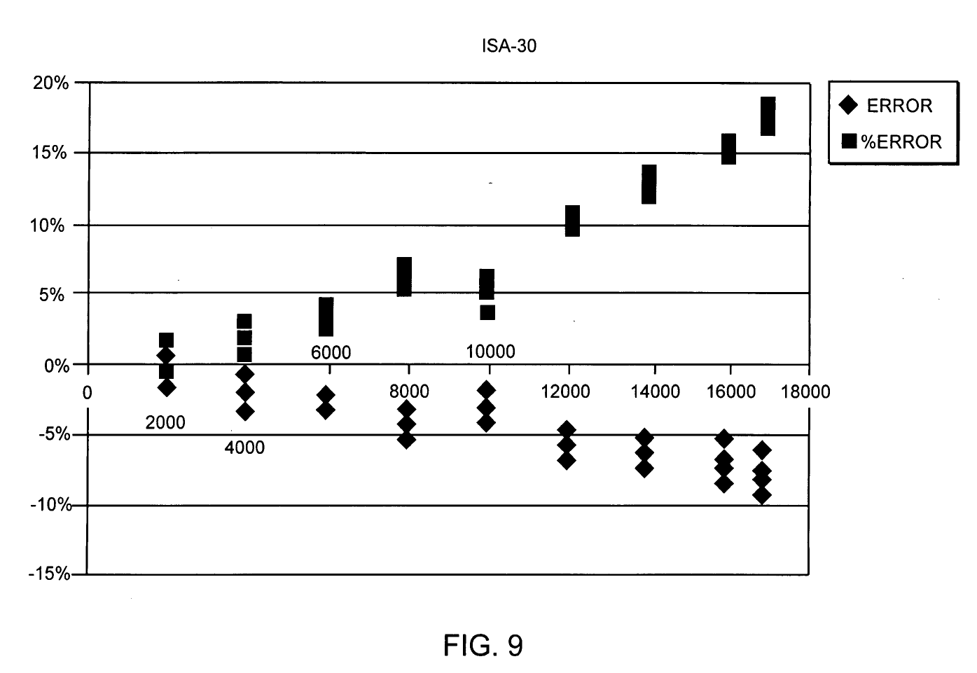

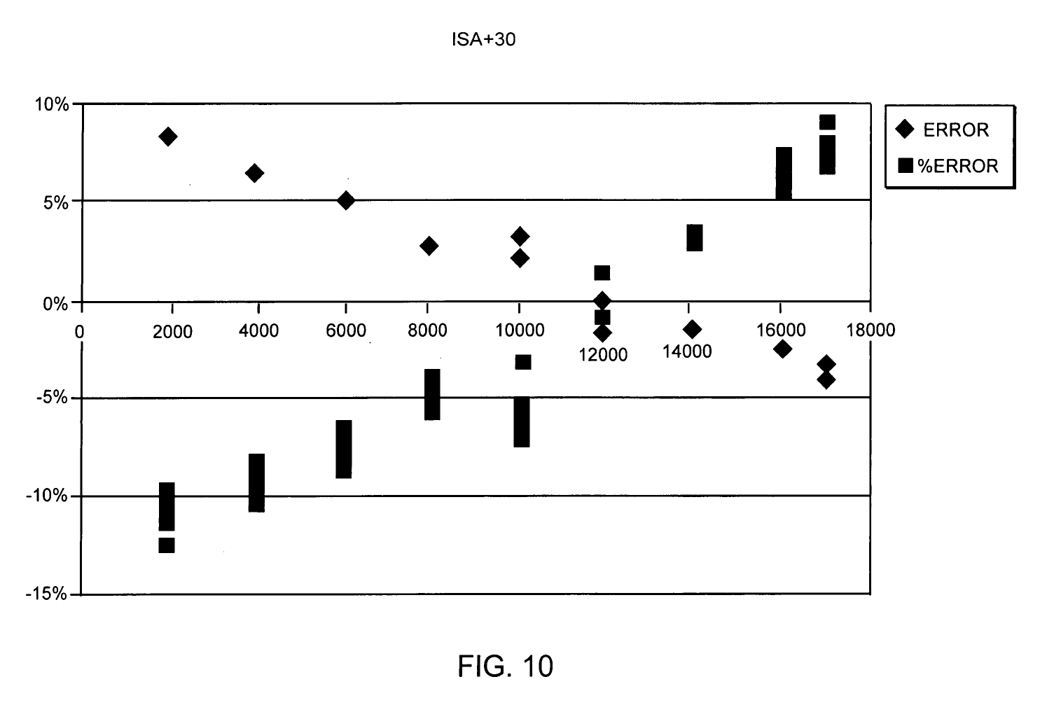

FIGS. 8, 9, and 10 show a typical dependence of discrepancies between the actual power produced by the engine and HP₁ and HP₂ (where available) on the engine's altitude (expressed on the horizontal axis in feet) at ISA conditions (FIG. 8), at ISA −30° C. (i.e., ambient sea level temperature being −15° C., FIG. 9), and at ISA +30° C. (i.e., ambient sea level temperature being 45° C., FIG. 10). In FIGS. 8, 9, and 10, the discrepancies produced by the above method for this engine are shown by diamonds as difference between the calculated and actual engine power (expressed as percentage of the engine's maximum power) and by squares as the percentage difference between the calculated and actual engine's power.

As can be seen from FIGS. 8, 9, and 10, at the ISA conditions, the invention method for this engine works the best (has the lower error) between approximately 6,000 and 8,000 feet of altitude.

Some embodiments including the ones shown above implement the following general approach.

The power output of an engine may be approximately calculated as HP₀ using manifold pressure, P, and engine rotations per minute, R, as
HP₀=A₁+A₂×R+A₃×P+A₄×P×R,

where A₁ through A₄ are coefficients which may be obtained from the engine's manufacturer, obtained by analysis of the engine's design and use, or measured directly by operating the engine under various conditions. Note that the power output HP₀ depends linearly on both the manifold pressure, P, and the engine rotations per minute, R, as can also be observed on FIGS. 1 and 6.

A better approximation of the power output, HP₁, may be calculated by taking into account the outside air temperature, T, as:
HP₁=HP₀×((T₀−T)×B+1.),

where B and T₀ are coefficients which may be obtained from the engine's manufacturer, obtained by analysis of the engine's design and use, or measured directly by operating the engine under various conditions. Note that HP₁=HP₀ when T=T₀. In one embodiment, T₀ is in the range 14° C. to 18° C.

The precision of the power output calculation may be further improved under the following combination of conditions:

(1) HP₁ is between 30% and 80% of the maximum power output of the engine;

(2) the fuel flow into the engine, F, is less than Fₘₐₓ gallons per minute; and

(3) F<C₁×HP₁+C₂

If the above conditions are true, the improved approximation for the engine's power output, HP₂, at a given fuel flow, F, may be calculated as

if F<(F_{BP}−F₀), i.e. lean mix,
HP₂=HP₁−D₀,
note that this value is constant for constant HP₁;

if (F_{BP}−F₀)≦F≦F_{BP},
HP₂=HP₁+(D₃×(F−(D₁×HP₁+D₂))³)+(D₄×(F−(D₁×HP₁+D₂))²)+(D₅×(F−(D₁×HP₁+D₂)))+D₆; and

if F_{BP}<F, i.e. rich mix,
HP₂=HP₁+(D₇×(F−(D₁×HP₁+D₂))−D₈),
note that this value depends linearly on F for constant HP₁;

where F_{BP} is the fuel flow at which the engine operates at its best power for the given manifold pressure, rotation rate, and outside air temperature determined by (D₁×HP₁+D₂), and C₁, C₂, F₀, and D₀ through D₈ are coefficients which may be obtained from the engine's manufacturer, obtained by analysis of the engine's design and use, or measured directly by operating the engine under various conditions.

Note that best power HP_{BP} is determined in the above equations by setting F equal to F_{BP}. Notice that generally, best power HP_{BP} will be equal to HP₁ plus or minus a constant factor D₆.

The typical ranges for the coefficients involved are:

A₁ from −100. to 100.;

A₂ from −0.1 to 0.1;

A₃ from −10. to 0.;

A₄from −0.01 to 0.01;

B from 0.001 to 0.05;

C₁ from 0.01 to 0.1;

C₂ from 0. to 10.;

F₀ from 0. to 10.;

D₀ from 0. to 310.;

D₁ from 0. to 0.1;

D₂ from 0. to 10.;

D₃ from −5. to 15.;

D₄ from −10. to 10.;

D₅ from −10. to 10.;

D₆ from −10. to 10.;

D₇ from −2. to 2.;

D₈ from −5. to 5.

Other embodiments of this invention using similar principles may be used with different engines and under different conditions.

As illustrated in the embodiments described above, the best power HP_{BP} and best fuel flow F_{BP} for a given engine speed, manifold pressure, and outside air temperature may be calculated. The computation device 14 may then determine the current power output HP₂ as a percentage or ratio of the current calculated best power HP_{BP} and show the percentage or ratio on the display 18.

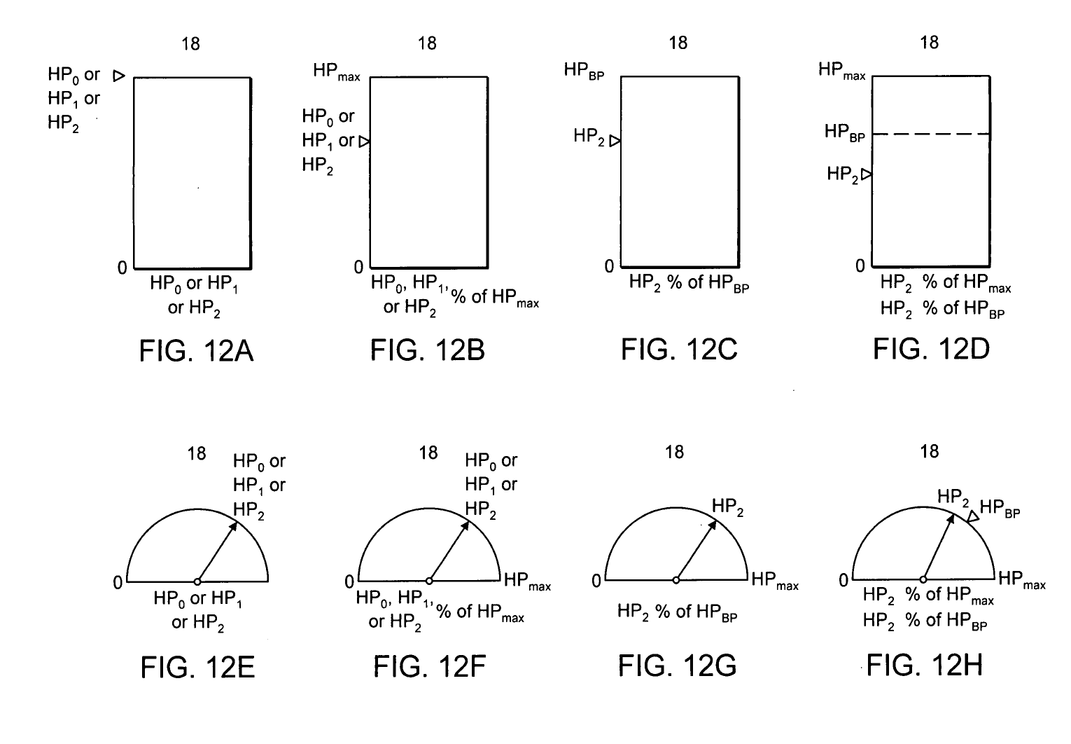

FIGS. 12A-H illustrate eight possible embodiments of the display 18 of the invention. FIGS. 12A and 12E illustrate embodiments of the display 18 showing the value of either HP₀, HP₁, or HP₂ as a bar scale and as a needle on a dial respectively. Below the scale or dial, HP₀, HP₁, or HP₂ is displayed in numerical fashion. FIGS. 12B and 12F illustrate embodiments of the display 18 showing the value of HP₀, HP₁, or HP₂ as a percentage or ratio of the maximum power HP_{MAX} of the engine on a bar scale and as a needle on a dial respectively where one end of the scale or dial is zero power and the other end of the scale or dial is maximum power HP_{MAX}. Below the scale or dial, HP₀, HP₁, or HP₂ is displayed in numerical form as either a percentage or ratio of HP_{MAX}. FIGS. 12C and 12G illustrate embodiments of the display 18 showing the value of HP₂ as a percentage or ratio of the best power HP_{BP} of the engine at the given engine speed, manifold pressure, and outside air temperature on a bar scale and as a needle on a dial respectively where one end of the scale or dial is zero power and the other end of the scale or dial is the best power HP_{BP}. Below the scale or dial, HP₀, HP₁, or HP₂ is displayed in numerical form as either a percentage or ratio of HP_{BP}. FIGS. 12D and 12H illustrate embodiments of the display 18 showing a bar scale and a needle on a dial respectively where one end of the scale or dial is zero power and the other end of the scale or dial is the maximum power of the engine. The scale and dial of FIGS. 12D and 12H respectively simultaneously indicate both the calculated power HP₂ and the best power HP_{BP} of the engine as a percentage or ratio of the maximum power HP_{MAX} of the engine. Below the scale or dial, HP₀, HP₁, or HP₂ is displayed in numerical form as either a percentage or ratio of HP_{MAX} or HP_{BP}.

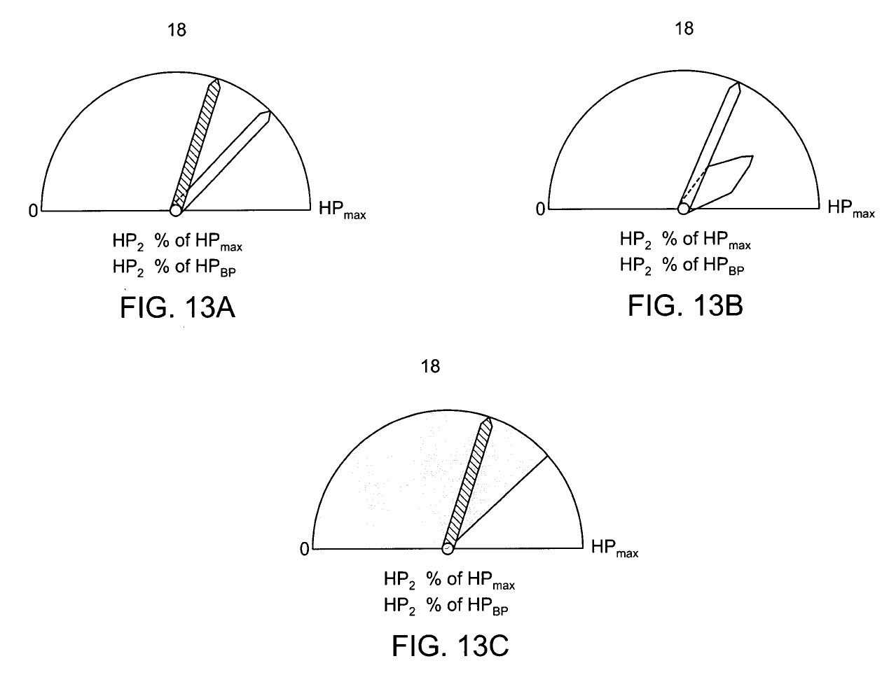

FIGS. 13A-C illustrate three additional possible embodiments of the display 18 where both the calculated engine power HP₂ and the calculated current best power HP_{BP} are shown relative to the maximum power HP_{MAX} of the engine. FIG. 13A illustrates an embodiment of display 18 showing HP₂ and HP_{BP} each as an equally sized needle on a dial. The two needles are differentiated by having different colors or patterns on them. FIG. 13A shows one possible color scheme where the HP_{BP} needle and the HP₂ needle are differentiated by color or pattern. Below the dial, HP₂ is displayed in numerical form as either a percentage or ratio of HP_{BP} or HP_{MAX}. FIG. 13B illustrates an embodiment of display 18 showing HP₂ and HP_{BP} as differently sized needles on a dial. Below the dial, HP₂ is displayed in numerical form as either a percentage or ratio of HP_{BP} or HP_{MAX}. FIG. 13C illustrates an embodiment of display 18 showing HP₂ as a needle on a dial and HP_{BP} as a filled-in portion of the dial. Below the dial, HP₂ is displayed in numerical form as either a percentage or ratio of HP_{BP} or HP_{MAX}. Other graphical and/or numerical displays and combinations are also suitable.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of determining the power of an engine comprising the computer implemented steps of:
obtaining a detected rotation rate of the engine;
obtaining a detected manifold pressure of the engine;
obtaining a detected outside air temperature of the engine; and
calculating a best power HP_{BP} output of the engine by combining the detected rotation rate of the engine, the detected manifold pressure of the engine, and the detected outside air temperature.

2. The method of claim 1, further comprising the computer implemented steps of:
obtaining a detected fuel flow rate of the engine; and
calculating a power output HP₂ of the engine by combining the detected fuel flow of the engine, the detected manifold pressure of the engine, and the detected outside air temperature of the engine.

3. The method of claim 2, further comprising the computer implemented step of:
relating the calculated best power HP_{BP} of the engine to the calculated power HP₂ of the engine to determine the calculated power HP₂ as a percentage or ratio of the best power HP_{BP} output.

4. The method of claim 3, further comprising the step of providing a display indication of calculated power HP₂ relative to at least the calculated best power HP_{BP} of the engine.

5. The method of claim 3, further comprising the computer implemented step of:
relating a maximum power HP_{MAX} of the engine to the calculated power HP₂ of the engine to determine the calculated power HP₂ as a percentage or ratio of the maximum power HP_{MAX} output.

6. The method of claim 5, further comprising the step of providing a display indication of calculated power HP₂ relative to at least the maximum power HP_{MAX} output of the engine.

7. The method of claim 5, further comprising the step of providing a display indication of calculated power HP₂ relative to at least the calculated best power HP_{BP} of the engine and to the maximum power HP_{MAX} output of the engine.

8. The method of claim 1, wherein the engine is an aircraft engine.

9. An apparatus for determining best power HP_{BP} of an engine comprising:
a computation device calculating best power HP_{BP} of the engine by mathematically combining a detected rotation rate of the engine, a detected manifold pressure of the engine, and a detected outside air temperature; and
a data input system coupled to the computation device, the data input system providing detected engine rotation rate, detected engine manifold pressure, and detected outside air temperature to the computation device.

10. The apparatus of claim 9, wherein the computation device determines a calculated power output HP₂ of the engine by performing further calculations with a detected fuel flow rate of the engine and the data input system provides the detected fuel flow rate of the engine to the computation device.

11. The apparatus of claim 10, wherein the computation device relates the calculated power output HP₂ of the engine to the best power HP_{BP} of the engine to determine the calculated power HP₂ as a percentage or ratio of the best power HP_{BP} output.

12. The apparatus of claim 11, further comprising a display coupled to the computation device for providing an indication of calculated power output HP₂ relative to at least the best power HP_{BP} of the engine.

13. The apparatus of claim 11, wherein the computation device relates the calculated power output HP₂ of the engine to a maximum power HP_{MAX} of the engine to determine the calculated power HP₂ as a percentage or ratio of the maximum power HP_{MAX} output.

14. The apparatus of claim 13, further comprising a display coupled to the computation device for providing an indication of calculated power output HP₂ relative to at least the maximum power HP_{MAX} output of the engine.

15. The apparatus of claim 13, further comprising a display coupled to the computation device for providing an indication of calculated power output HP₂ relative to the best power HP_{BP} of the engine and the maximum power HP_{MAX} output of the engine.

16. The apparatus of claim 9, wherein the engine is an aircraft engine.

17. A computer program product for determining power of an engine comprising:
a computer readable medium; and
computer instructions embodied on the computer readable medium, wherein the computer instructions when executed on a computer causes the computer to:
obtain a detected rotation rate of the engine, obtain a detected manifold pressure of the engine, and obtain a detected outside air temperature of the engine; and
determine a best power HP_{BP} output of the engine by approximating best power output based on a combination of the obtained rotation rate of the engine, the obtained manifold pressure of the engine, and the obtained outside air temperature, wherein the best power output is determined in a manner free of using a measured altitude of the engine.

18. The computer program product of claim 17, wherein the computer instructions embodied in the computer readable medium further comprise computer instructions which when executed by a computer cause the computer to calculate a power output HP₂ of the engine by:
obtaining a detected fuel flow of the engine; and
combining the detected fuel flow rate of the engine, the detected rotation rate of the engine, the detected manifold pressure of the engine, and the detected outside air temperature to form a calculated power HP₂ output.

19. The computer program product of claim 18, wherein the computer instructions embodied on the computer readable medium further comprise computer instructions which when executed by the computer cause the computer to:
relate the best power HP_{BP} output of the engine with the calculated power HP₂ of the engine; and
determine the calculated power HP₂ as a percentage or ratio of the best power HP_{BP} output.

20. The computer program product display of claim 19, wherein the computer instructions further includes instructions for providing display of calculated power HP₂ of the engine relative to at least the best power HP_{BP} of the engine.

21. The computer program product of claim 19, wherein the computer instructions embodied on the computer readable medium further comprise computer instructions which when executed by the computer cause the computer to:
relate a maximum power HP_{MAX} output of the engine with the calculated power HP₂ of the engine; and
determine the calculated power HP₂ as a percentage or ratio of the maximum power HP_{MAX} output of the engine.

22. The computer program product display of claim 21, wherein the computer instructions further includes instructions for providing display of calculated power HP₂ of the engine relative to at least the maximum power HP_{MAX} output of the engine.

23. The computer program product display of claim 21, wherein the computer instructions further includes instructions for providing display of calculated power HP₂ of the engine relative to the best power HP_{BP} of the engine and to the maximum power HP_{MAX} output of the engine.

24. The computer program product of claim 17 wherein the engine is an aircraft engine.
